(19) United States
(12) Patent Application Publication
(10) Pub. No.: US 2018/0376176 A1
(43) Pub. Date: Dec. 27, 2018

(54) QUALITY-OF-EXPERIENCE OPTIMIZATION APPARATUS, NETWORK QUALITY ESTIMATION APPARATUS, MOBILE TERMINAL, QUALITY-OF-EXPERIENCE OPTIMIZATION METHOD, NETWORK QUALITY ESTIMATION METHOD, AND PROGRAM

(71) Applicant: NIPPON TELEGRAPH AND TELEPHONE CORPORATION, Chiyoda-ku (JP)

(72) Inventors: Arifumi MATSUMOTO, Musashino-shi (JP); Masahiro YOKOTA, Musashino-shi (JP); Takuto KIMURA, Musashino-shi (JP)

(73) Assignee: NIPPON TELEGRAPH AND TELEPHONE CORPORATION, Chiyoda-ku (JP)

(21) Appl. No.: 15/780,508

(22) PCT Filed: Dec. 1, 2016
(86) PCT No.: PCT/JP2016/085757

§ 371 Date: May 31, 2018

(30) Foreign Application Priority Data
Dec. 2, 2015 (JP) 2015-236086

(51) Int. Cl. H04N 21/234; H04N 21/2387; H04N 21/24; H04N 21/845

(52) U.S. Cl. CPC H04N 21/23418; H04N 21/8456; H04N 21/24; H04N 21/2387

(57) ABSTRACT

A quality-of-experience optimization apparatus including: a quality related information database that stores quality information indicating network quality together with time information indicating a time when the network quality was measured, and position information indicating a position where the network quality was measured; an estimator that obtains, from the quality related information database, quality information that satisfies a predetermined condition corresponding to a playback position that is a position where playback of the video is performed and to a playback time that is a time when the playback is performed, and estimates network quality at the playback position and the playback time based on the quality information; and a calculator that calculates a recommended value of a coding condition of the video such that quality of experience of the video is optimized based on the network quality estimated by the estimator and coding conditions that are usable for the video.

### TECHNICAL FIELD

The present invention relates to a video distribution control technique for optimizing user's quality of experience (QoE: Quality of Experience) for a video provided by a video distribution service.

### BACKGROUND ART

In recent years, video distribution services via networks have been widespread. In particular, a distribution scheme called a streaming type is widely used. In the streaming type video distribution, the server side divides the video data into smaller data chunks (chunks) and delivers the chunks, and the client side playbacks the chunks as needed while downloading the chunks. At this time, in many cases, the server stores data obtained by encoding original moving image data with several coding bit rates, so that the client can select a coding bit rate for playback when starting playback.

When selecting a coding bit rate, if a high bit rate is selected, resolution of the video becomes high. However, since the amount of data per chunk increases, there is a high possibility that playback is stopped due to lack of data acquisition. On the other hand, if a low bit rate is selected, the video image is deteriorated. However, since the amount of data per chunk decreases, the possibility of stop of playback decreases. That is, there is a trade-off relationship between the coding bit rate and playback stop, and it is necessary to establish a bit rate selection scheme that keeps the balance well.

### RELATED ART DOCUMENT

### Non Patent Document

[NON PATENT DOCUMENT 1] Hiroshi YAMAMOTO, “[Special Talk] Toward QoE-centric Operation of Telecommunication Services”, IEICE Technical Report, vol. 114, no. 299, pp. 49-52, November 2014

[NON PATENT DOCUMENT 2] Xiaoqi Yin, Abhishek Jindal, Vyas Sekar, Bruno Sinopoli, A Control-Theoretic Approach for Dynamic Adaptive Video Streaming over HTTP, In proc. ACM SIGCOMM, August 2015

### SUMMARY OF THE INVENTION

### Problem to By Solved by the Invention

In response to the above-mentioned problem, it is assumed that a distribution rate selection scheme focusing on the user quality of experience (QoE) is used. In this distribution rate selection scheme, for example, environment information of a user at the start of communication is acquired, so that degree of network quality is predicted from distribution history in the past similar environment. Then, a distribution rate (coding bit rate) is determined such that the highest QoE is obtained by using a model for estimating application quality and QoE from the estimated network quality information.

In the above-mentioned method, for estimating network quality, estimation of network quality is performed based on the environment of the user at the start time of communication. However, in recent years, video viewing from the mobile environment has increased, and the communication environment at the start of communication is not necessarily the same as the playback environment during video viewing.

For example, a situation is considered in which a user starts communication under a cell (CID) of a base station that is likely to be congested at the time of communication start and moves to a place with good communication environment during video viewing. At this time, In the above method, since the communication quality is predicted based on the CID and the time zone at the start of communication, the surplus band cannot be used up and the optimum QoE is not necessarily obtained in this situation. In addition, the same phenomenon occurs when the communication environment is good at the start time of communication and the communication environment deteriorates during playback.

The present invention has been made in view of the above points, and an object of the present invention is to provide a technique in which, even when a terminal that receives a video provided by a video distribution service moves, the terminal can receive a video for which quality of experience is optimized in the environment of the moving destination of the terminal.

### Means for Solving the Problem

According to an embodiment of the present invention, there is provided a quality-of-experience optimization apparatus for optimizing quality of experience that a user experiences for a video distributed from a video distribution server via a network, including:

a quality related information database that stores quality information indicating network quality together with time information indicating a time when the network quality was measured, and position information indicating a position where the network quality was measured;

estimation means that obtains, from the quality related information database, quality information that satisfies a predetermined condition corresponding to a playback position that is a position where playback of the video is performed and to a playback time that is a time when the playback is performed, and estimates network quality at the playback position and the playback time based on the quality information; and

calculation means that calculates a recommended value of a coding condition of the video such that quality of experience of the video is optimized based on the network quality estimated by the estimation means and coding conditions that are usable for the video.

According to an embodiment of the present invention, there is provided a network quality estimation apparatus for estimating network quality that is used for optimizing quality of experience that a user experiences for a video distributed from a video distribution server via a network, including:

a quality related information database that stores quality information indicating network quality together with time information indicating a time when the network quality was measured, and position information indicating a position where the network quality was measured; and

estimation means that obtains, from the quality related information database, quality information that satisfies a predetermined condition corresponding to a playback position that is a position where playback of the video is performed and to a playback time that is a time when the playback is performed, and estimates network quality at the playback position and the playback time based on the quality information.

According to an embodiment of the present invention, there is provided a quality-of-experience optimization method executed by a quality-of-experience optimization apparatus for optimizing quality of experience that a user experiences for a video distributed from a video distribution server via a network,

wherein the quality-of-experience optimization apparatus includes a quality related information database that stores quality information indicating network quality together with time information indicating a time when the network quality was measured, and position information indicating a position where the network quality was measured, the quality-of-experience optimization method including:

an estimation step of obtaining, from the quality related information database, quality information that satisfies a predetermined condition corresponding to a playback position that is a position where playback of the video is performed and to a playback time that is a time when the playback is performed, and estimating network quality at the playback position and the playback time based on the quality information; and

a calculation step of calculating a recommended value of a coding condition of the video such that quality of experience of the video is optimized based on the network quality estimated by the estimation step and coding conditions that are usable for the video.

According to an embodiment of the present invention, there is provided a network quality estimation method executed by a network quality estimation apparatus for estimating network quality that is used for optimizing quality of experience that a user experiences for a video distributed from a video distribution server via a network,

wherein the network quality estimation apparatus includes a quality related information database that stores quality information indicating network quality together with time information indicating a time when the network quality was measured, and position information indicating a position where the network quality was measured, the network quality estimation method including:

an estimation step of obtaining, from the quality related information database, quality information that satisfies a predetermined condition corresponding to a playback position that is a position where playback of the video is performed and to a playback time that is a time when the playback is performed, and estimating network quality at the playback position and the playback time based on the quality information.

### Effect of the Present Invention

According to an embodiment of the present invention, there is provided a technique in which, even when a terminal that receives a video provided by a video distribution service moves, the terminal can receive a video for which quality of experience is optimized in the environment of the moving destination of the terminal.

### BRIEF DESCRIPTION OF THE DRAWINGS

FIG. 1 is a diagram showing a configuration example of a quality-of-experience optimization system 100 in an embodiment of the present invention;

FIG. 2 is a diagram showing an example of information held by the video distribution server 20;

FIG. 3 is a diagram showing a configuration example of a mobile terminal 10 and a quality-of-experience optimization apparatus 30;

FIG. 4 is a diagram showing an example of information stored in a quality related information DB 13 in the mobile terminal 10;

FIG. 5 is a diagram showing an example of information stored in a quality related information DB 33 in the quality-of-experience optimization apparatus 30;

FIG. 6 is a diagram showing a hardware configuration example of the quality-of-experience optimization apparatus 30 and the mobile terminal 10;

FIG. 7 is a sequence diagram for explaining operation of the quality-of-experience optimization system 100;

FIG. 8 is a diagram showing a configuration example of a mobile terminal 10 and a quality-of-experience optimization apparatus 30 in a modified example;

FIG. 9 is a sequence diagram for explaining operation of the quality-of-experience optimization system 100 in a modified example.

### EMBODIMENTS FOR CARRYING OUT THE INVENTION

In the following, an embodiment of the present invention (present embodiment) is described with reference to figures. The embodiment described below is merely an example, and embodiments to which the present invention is applied are not limited to the following embodiments.

(System Whole Configuration, Configuration of Each Apparatus and the Like)

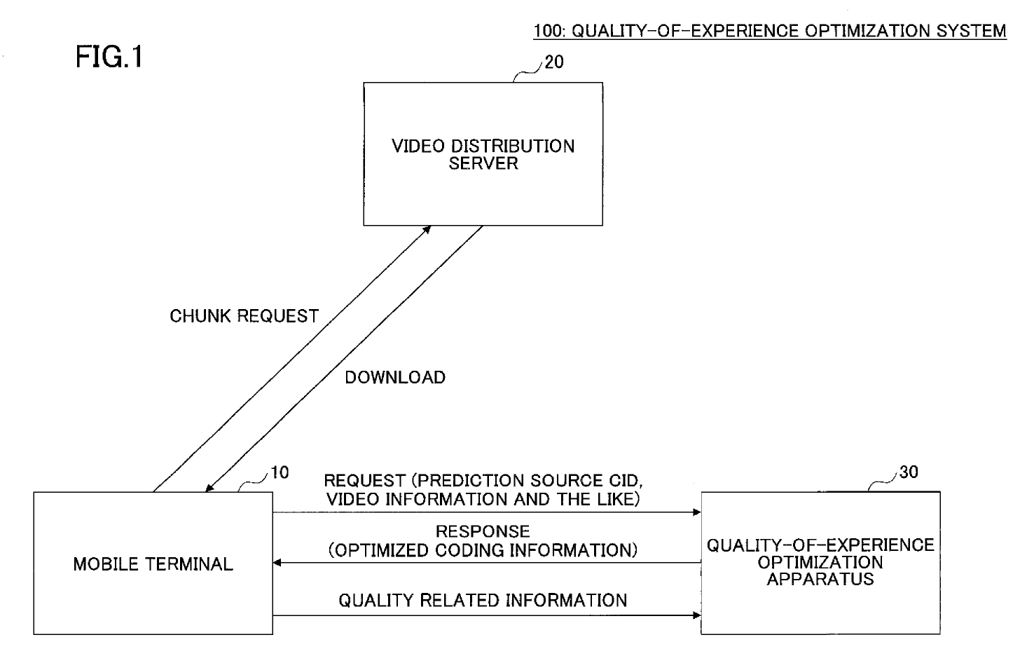

FIG. 1 shows a configuration example of a quality-of-experience optimization system 100 in the present embodiment. As shown in FIG. 1, the quality-of-experience optimization system 100 includes a mobile terminal 100, a video distribution server 20 and a quality-of-experience optimization apparatus 30.

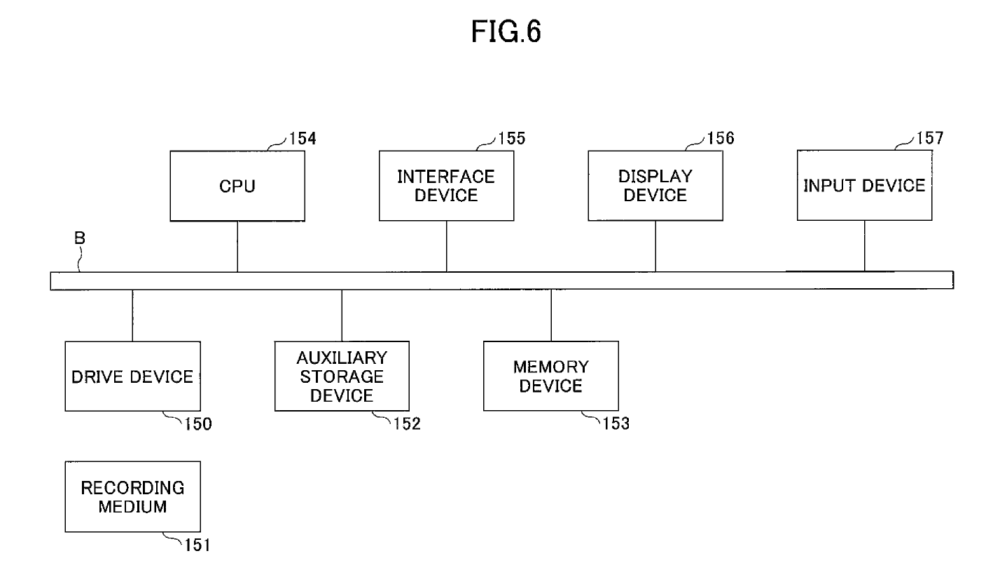

In the quality-of-experience optimization system 100 shown in FIG. 1, the mobile terminal 10 and the video distribution server 20, and the mobile terminal 10 and the quality-of-experience optimization apparatus 30 are connected via a network such as the Internet, respectively, and data transmission and reception is possible. Although one mobile terminal 10 is shown in FIG. 1, in reality, many mobile terminals 10 are present in various places. Also, in FIG. 1, although information transmitted and received between the apparatuses is shown, the transmission and reception procedures and the like will be described in the operation description with reference to FIG. 6.

<Video Distribution Server 20>

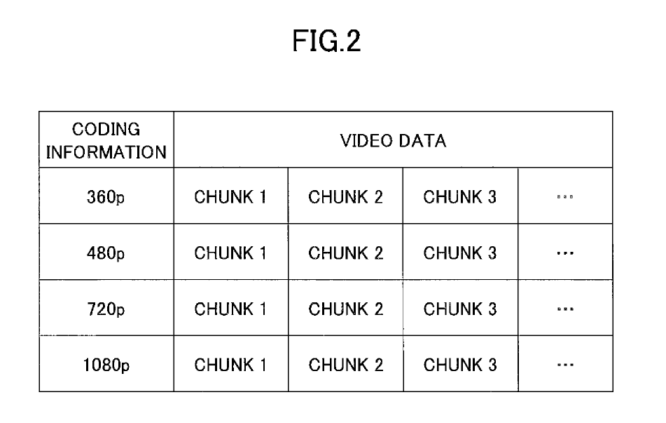

The video distribution server 20 in the quality-of-experience optimization system 100 is a server for video distribution of the streaming type. As shown in FIG. 2, the video distribution server 20 holds video data for each coding information (which may be also referred to as coding condition), and the video distribution server 20 holds the video data as units called chunks obtained by dividing the video data every 1 to 5 seconds. In the example shown in FIG. 2, a frame rate is shown as coding information, however, this is an example, and video data may be held for each coding bit rate, for each resolution. The mobile terminal 10 requests, to the video distribution server 20, a chunk of a specific coding bit rate/resolution/frame rate, so as to download the chunk and performs playback and display.

<Mobile Terminal 10>

The mobile terminal 10 is, for example, a smartphone, a tablet, a small-sized PC or the like, and includes a communication function for transmitting/receiving data to/from another device (the video distribution server 20 or the like) via a network. In the present embodiment, the network includes a cellular network (mobile phone network), and the mobile terminal 10 performs radio communication with a base station of the cellular network. Further, by accessing the cellular network, the mobile terminal 10 acquires CID (cell ID) which is an identifier for identifying the residing cell (base station).

In the present embodiment, the CID is used as position information for identifying the position of the mobile terminal 10, however, this is merely an example, and other position information may be used. For example, latitude/longitude information acquired by the GPS function of the mobile terminal 10 may be used instead of the CID. Also, both of the CID and the latitude/longitude information may be used.

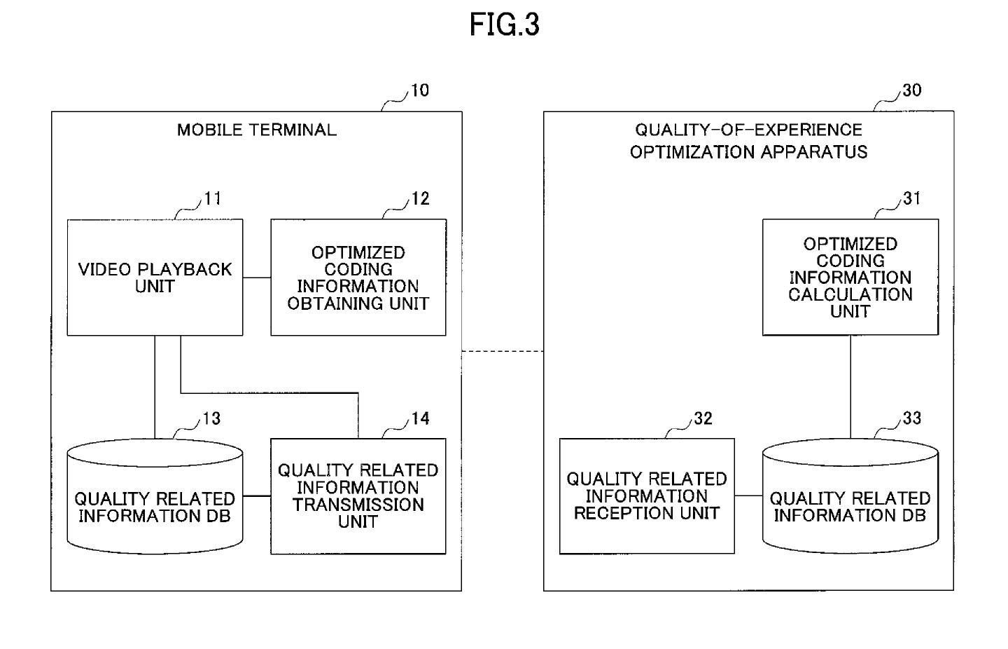

FIG. 3 is a diagram showing a configuration example of the mobile terminal 100 and the quality-of-experience optimization apparatus 30. Note that FIG. 3 is a diagram showing functional units particularly related to the present embodiment in the mobile terminal 10 and the quality-of-experience optimization apparatus 30, and each of the mobile terminal 10 and the quality-of-experience optimization apparatus 30 includes existing functions not shown in the figure for performing general communication processing and the like. In the following, the configuration of the mobile terminal 10 is described.

As shown in FIG. 3, the mobile terminal 10 includes a video playback unit 11, an optimized coding information obtaining unit 12, a quality related information DB (database) 13, and a quality related information transmission unit 14.

The video playback unit 11 includes functions for requesting, to the video distribution server 20, a chunk corresponding to a specific coding condition so as to download the chunk from the video distribution server 20, and playback (decode) the chunk (coded video data) and display a video. Also, the video playback unit 11 includes a cellular communication function, and includes functions for receiving (obtaining) the CID from the base station when connecting to the cellular network or when moving between cells. Further, the video playback unit 11 includes functions for, when downloading the chunk, measuring throughput, and storing the measurement result in the quality related information DB 13 with the time when measurement was performed and the CID at the time of measurement. Note that the throughput is an example of network quality. Data consisting of the measurement time and the throughput is called time-series information of throughput. Also, the video playback unit 11 has a buffer for temporarily storing the downloaded chunk (coded video data) to playback data of the chunk by reading the data of the chunk from the buffer. The video playback unit 11 may measure the buffer amount (the amount of data stored in the buffer), for example, at regular time intervals, and store the buffer amount in a storage unit (example: the quality related information DB 13) together with the measurement time. Data consisting of the measurement time and the buffer amount is called time-series information of buffer amount.

For example, when the CID is changed as a trigger, the optimized coding information obtaining unit 12 has functions for receiving optimized coding information as a response from the quality-of-experience optimization apparatus 30 by transmitting a request including a CID to the quality-of-experience optimization apparatus 30, and notifying the video playback unit 11 of the optimized coding information as the above-mentioned coding condition.

The quality related information DB 13 is storage means that stores the quality related information such as the throughput measured at the time of downloading the chunk as described above. Including the throughput at the time of download of the chunk in the quality related information is an example, it is not limited to this, other values may be measured and stored.

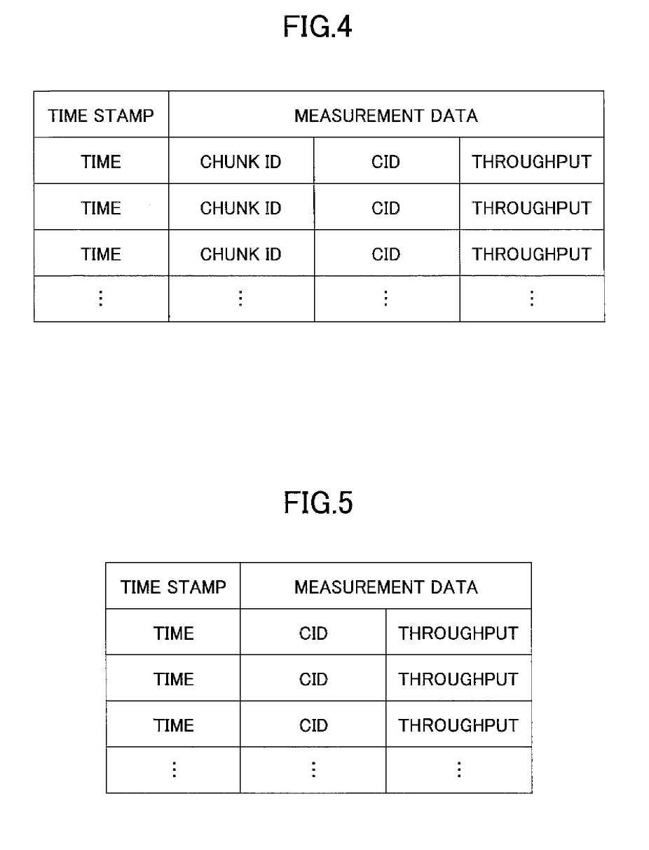

FIG. 4 shows an example of information stored in the quality related information DB 13. As shown in FIG. 4, the quality related information DB 13 stores ID (chunk ID) of a chunk whose throughput is to be measured, CID (position information of the mobile terminal 10 when throughput is measured) acquired from the base station by the mobile terminal 10 at the time of throughput measurement, and the time when the throughput was measured (example: year/month/day/hour, minute, second and the like) are stored.

The quality related information transmission unit 14 of the mobile terminal 10 has functions to read quality related information from the quality related information DB 13 and transmit it to the quality-of-experience optimization apparatus 30. The timing at which the quality related information transmission unit 14 transmits the quality related information to the quality-of-experience optimization apparatus 30 is not limited to a specific timing, but for example, it is transmitted based on an instruction from the video playback unit 11 when video viewing ends. Also, it may be transmitted at regular intervals. Also, the quality related information corresponding to the CID before the change may be transmitted at the timing when the CID is changed.

The mobile terminal 10 in the present embodiment can be realized by causing a terminal including a computer (CPU and a memory and the like) such as a smartphone and a tablet, for example, to execute a program which describes the process content described in the present embodiment. More specifically, the functions of the mobile terminal 10 can be realized by executing a program corresponding to processes performed by the mobile terminal 10 by using hardware resources such as a CPU, and a memory and the like in the computer. The program can be saved and distributed by recording the program in a computer readable recording medium (such as portable memory). Also, the program can be provided via a network such as the Internet, an electronic mail and the like.

<Quality-of-Experience Optimization Apparatus 30>

Next, configuration of the quality-of-experience optimization apparatus 30 is described. As shown in FIG. 3, the quality-of-experience optimization apparatus 30 includes an optimized coding information calculation unit 31, a quality related information reception unit 32, and a quality related information DB 33.

The optimized coding information calculation unit 31 includes functions that, in response to receiving a request including a CID and video information from the mobile terminal 10, predict throughout in the current position of the mobile terminal 10 based on the CID and the current position, and quality related information stored in the quality related information DB 33, determine coding conditions (coding bit rate, frame rate, resolution and the like) optimizing quality of experience based on the throughput and the video information and the like, and transmit the coding conditions to the mobile terminal 10 as the optimized coding information. Note that “optimization” in the present embodiment means obtaining good quality of experience as much as possible by executing processing described in the present embodiment.

The quality related information reception unit 32 have functions that receive quality related information from the mobile terminal 10, and store the quality related information in the quality related information DB 33.

FIG. 5 shows an example of information stored in the quality related information DB 33 of the quality-of-experience optimization apparatus 30. As shown in FIG. 5, time and a measurement result (CID, throughput) at the time are stored.

The quality-of-experience optimization apparatus 30 in the present embodiment can be realized by causing one or more computers, for example, to execute a program which describes the process content described in the present embodiment. More specifically, the functions of the quality-of-experience optimization apparatus 30 can be realized by executing a program corresponding to processes performed by the quality-of-experience optimization apparatus 30 by using hardware resources such as a CPU, and a memory and the like in the computer. The program can be saved and distributed by recording the program in a computer readable recording medium (such as portable memory). Also, the program can be provided via a network such as the Internet, an electronic mail and the like.

FIG. 6 is a diagram illustrating an example of a hardware configuration of the quality-of-experience optimization apparatus 30 in the case when the quality-of-experience optimization apparatus 30 is realized by the computer. The quality-of-experience optimization apparatus 30 in FIG. 6 includes a drive device 150, an auxiliary storage device 152, a memory device 153, a CPU 154, an interface device 155, a display device 156 and an input device 157 and the like, which are mutually connected by a bus B.

A program that implements processing on the quality-of-experience optimization apparatus 30 is provided by a recording medium 151 such as a CD-RUM or a memory card or the like. When the recording medium 151 storing the program is set in the drive device 150, the program is installed into the auxiliary storage device 152 from the recording medium 151 via the drive device 150. However, installation of the program is not necessarily executed from the recording medium 151, and may also be downloaded from another computer via the network. The auxiliary storage device 152 stores the installed program, and stores required files, data, and the like as well.

Upon receiving a command to activate the program, the memory device 153 reads the program from the auxiliary storage device 152, to load the program. The CPU 154 realizes a function which relates to the quality-of-experience optimization apparatus 30 according to the program stored in the memory device 153. The interface device 155 is used as an interface for connecting with the network. The display device 156 displays a GUI (Graphical User interface) and the like by the program. The input device 137 is formed by a keyboard and a mouse, a button or a touch panel and the like, and is used by inputting various operation instructions.

FIG. 6 is also a figure showing a hardware configuration example when the mobile terminal 10 is realized by a computer. The point that the mobile terminal 10 and the quality-of-experience optimization apparatus 30 can be realized by a computer and a program, and these hardware configuration examples are also the same in the modified examples described later.

In the examples shown in FIGS. 1 and 3, the mobile terminal 10 and the quality-of-experience optimization apparatus 30 are separate apparatuses, but the mobile terminal 10 may have the function of the quality-of-experience optimization apparatus 30. In this case, the mobile terminal 10 includes the function of the optimized coding information calculation unit 31 in addition to the video playback function. Also, in this case, as the quality related information used for throughput prediction, the quality related information obtained by the mobile terminal 10 itself at various places and times may be used, or a server for collecting quality related information from a plurality of mobile terminals may be provided to obtain the quality related information from the server. Also, the mobile terminal 10 in this case may be referred to “quality-of-experience optimization apparatus”.

(Operation of the System)

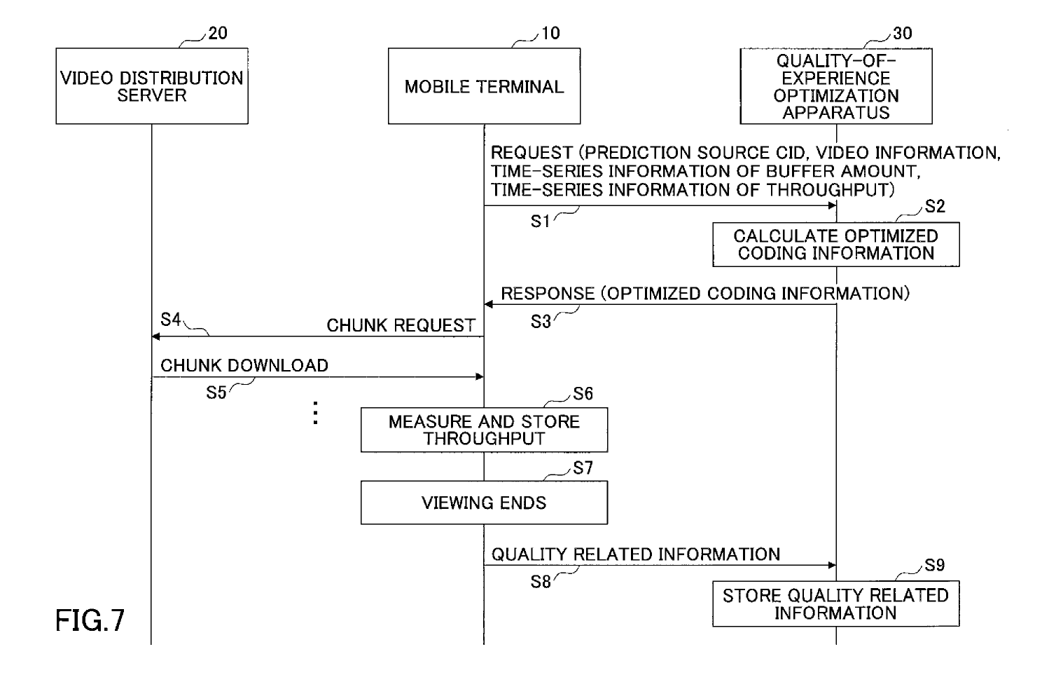

Next, an operation example of the quality-of-experience optimization system 100 in the present embodiment is described with reference to the sequence diagram of FIG. 7.

First, the optimized coding information obtaining unit 12 of the mobile terminal 10 transmits, to the quality-of-experience optimization apparatus 30, a request including a CID of the current location of the mobile terminal 10, video information, time-series information of the buffer amount, and time-series information of throughout (step S1). The timing when step S1 is executed is when video viewing starts, or the cell (base station) where the mobile terminal 10 resides changes (that is, the CID changes), or the like.

Note that, in step S1, it is merely an example that the information transmitted from the mobile terminal 10 to the quality-of-experience optimization apparatus 30 includes the CID of the current location, the video information, the time-series information of the buffer amount, and the time-series information of the throughput. According to the calculation method of the optimized coding information in the duality-of-experience optimization apparatus 30, the information transmitted from the mobile terminal 10 to the quality-of-experience optimization apparatus 30 may be determined as needed. For example, the information transmitted from the mobile terminal 10 to the quality-of-experience optimization apparatus 30 may be the CID of the current location and the video information.

In the case when the video starts, for example, if a user designate a video to view to the video playback unit 11, the video playback unit 11 notifies the optimized coding information obtaining unit 12 of the current CID and video information of the designated video (example: coding information such as bit rate that can be used for the video), so that step S1 starts.

In the case when the residing cell (base station) changes, for example, if the video playback unit 11 detects change of the CID, the video playback unit 11 notifies the optimized coding information obtaining unit 12 of a changed CID and video information (example: one used when viewing starts), so that step S1 starts. In the case where step S1 is executed in response to the CID change, the video information may not be transmitted. This is because it is transmitted at the time of viewing start.

As for the video information (coding information such as bit rate, resolution, frame rate and the like that can be used for the video designated by the user), it can be obtained from meta information (example: MPD (Media Presentation Description) in MPEG-DASH) on the video that the video playback unit 11 receives from the video distribution server 20.

The optimized coding information calculation unit 31 of the quality-of-experience optimization apparatus 30 that receives the request transmitted in step S1 calculates optimized coding information (step S2).

Here, first, the optimized coding information calculation unit 31 searches the quality related information DB 33 (example: FIG. 5) based on the CID included in the request and the current time (corresponding to playback time when playback of the video is performed in the mobile terminal 10) to obtain throughput data measured in the past under similar condition corresponding to the CID and the playback time, and calculates a throughput prediction value in the current mobile terminal 10 by calculating the average of the throughput data, for example. Throughput data under similar conditions in the past means, for example, throughput data measured at the same time zone (for example, 6 p.m.-8 p.m., etc.) on the same day of the week as the current time, in which the CID is the same as the CID of the request, and the like. The optimized coding information calculation unit 31 calculates, for example, an average of throughputs and a variance of the throughputs as the throughput prediction value, but these are examples, and values other than these may be calculated, or only the average of the throughputs may be calculated.

As a more specific example, the throughput prediction value may be calculated by the method described below. In the example described below, time-series information of the throughput received from the mobile terminal 10 is used together with the average value of throughputs under similar conditions in the past.

Here, as the time-series information of throughputs, it is assumed that x₁, x₂, . . . xₙ is obtained. It is assumed that n is an integer of 1 or more and that the throughput acquisition time is closer to the current time as the numerical value of the subscript is smaller. That is, the throughput acquisition time of x₁ is closest to the current time. In this case, the throughput prediction value is calculated by, for example, the following equation 1 or 2.

αΣⁿᵢ₌₁((1/i)×xᵢ)+(1−α)m equation 1

α(1/n)Σⁿᵢ₌₁(xᵢ)+(1−α)m equation 2

In each of the above-equations, m is an average value of throughputs under similar conditions in the past, and α is a real number satisfying 0≤α≤1.

Next, the optimized coding information calculation unit 31 calculates a coding condition (coding bit rate, frame rate, resolution) for optimizing the quality of experience from the throughput prediction value, the time-series information on the buffer amount, the coding information such as the bit rates usable in the video, and the like. Then, the optimized coding information calculation unit 31 transmits the coding condition as the optimized coding information to the mobile terminal 10 (step S3). As a method of calculating the coding condition, for example, there are the following methods.

A subjective evaluation experiment of video quality is performed under various throughputs and various coding conditions (coding bit rate, frame rate, resolution) and the like, and a model equation (function etc.) for obtaining estimated quality of experience from a throughput and a coding condition is generated based on the obtained evaluation result, and the model equation is set as a program, for example, in the optimized coding information calculation unit 31 in advance. Note that an existing model equation may be used as the model equation without performing the subjective evaluation experiments. As the model equation, for example, there is the equation described in the non-patent document 2.

Then, the optimized coding information calculation unit 31 calculates the estimated quality of experience under each coding condition by inputting, to the model equation, various coding conditions (coding bit rate, frame rate, resolution) that can be used for the video received from the mobile terminal 10 as the video information, and the throughput prediction value and the like.

Then, the optimized coding information calculation unit 31 determines, as the optimized coding information, a coding condition by which the estimated quality of experience is the largest among the coding conditions having a coding bit rate lower than the throughput prediction value (example: throughput average).

By using a coding bit rate lower than the throughput prediction value, it becomes possible to view high quality video without causing playback stop, and the quality of experience is optimized.

The optimized coding information obtaining unit 12 of the mobile terminal 10 that receives the optimized coding information (coding bit rate, frame rate, resolution and the like) in step S3 of FIG. 7 notifies the video playback unit 11 of the optimized coding information. Note that the optimized coding information may be referred to as a recommended value.

Subsequently, the video playback unit 11 of the mobile terminal 10 requests the video distribution server 20 to send a chunk of the coding condition indicated by the optimized coding information (step S4), and downloads the chunk to playback the video (step S5). As time passes, steps S4 and S5 are repeatedly executed.

The video playback unit 11 of the mobile terminal 10 measures throughput in units of chunks when downloading the chunks, and stores the measured throughput information, the CID at that time, and time information in the quality related information DB 13 (example: FIG. 4) as quality related information (step S6).

When the video playback unit 11 detects that viewing completes by the end of the video or by viewing end instruction by the user and the like, the video playback unit 11 notifies the quality related information transmission unit 14 of the completion of viewing (step S7).

The quality related information transmission unit 14 that receives the notification reads the quality related information stored while the video is being viewed, and transmits the quality related information to the quality-of-experience optimization apparatus 30 (step S8). The quality related information reception unit 32 in the quality-of-experience optimization apparatus 30 receives the quality related information, and stores (adds) the quality related information in the quality related information DR 33. The quality related information transmission unit 14 may periodically read the quality related information from the quality related information DB 13 and transmit the quality related information to the quality-of-experience optimization apparatus 30.

### Modified Example

In the example explained so far, the quality-of-experience optimization apparatus 30 calculates the optimized coding information and notifies the mobile terminal 10 of the calculated optimized coding information, but this is only an example. The mobile terminal 10 may calculate the optimized coding information. In the following, an example in this case is described as a modified example. The differences from the examples explained so far are mainly described below.

### Apparatus Configuration Example in the Modified Example

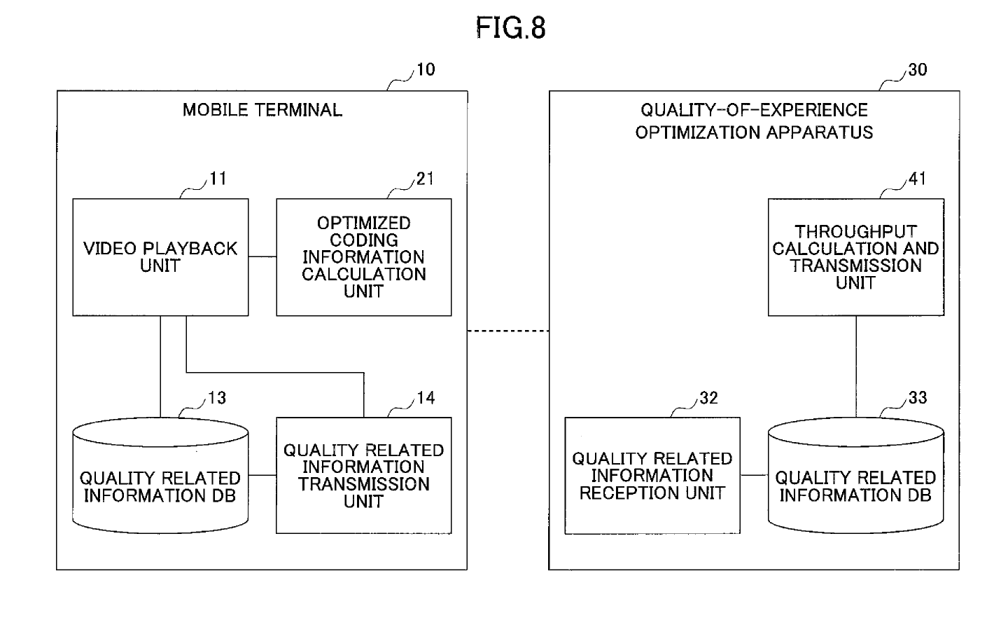

FIG. 8 is a diagram showing a configuration example of the mobile terminal 30 and the quality-of-experience optimization apparatus 30 in the modified example.

The mobile terminal 10 in the modified example includes the video playback unit 11, an optimized coding information calculation unit 21, the quality related information DB (database) 13, and the quality related information transmission unit 14. That is, the mobile terminal 10 in the modified example has the optimized coding information calculation unit 21 instead of the optimized coding information obtaining unit 12 in the mobile terminal 10 shown in FIG. 3. The video playback unit 11, the quality related information DB 13 and the quality related information transmission unit 14 are the same as those shown in FIG. 3.

The optimized coding information calculation unit 21 has functions that transmit a request including the CID to the quality-of-experience optimization apparatus 30, for example, upon the change of the CID as a trigger, receive, from the quality-of-experience optimization apparatus 30, a throughput prediction value (example: throughput average, throughput dispersion) as a response, calculate the optimized coding information (coding condition) based on the throughout prediction value using a method similar to the optimized coding information calculation unit 31 in the before-mentioned quality-of-experience optimization apparatus 30 (shown in FIG. 3), and notify the video playback unit 11 of the optimized coding information (coding condition).

The mobile terminal 10 in the modified example can be realized by causing a terminal including a computer (CPU and a memory and the like) such as a smartphone and a tablet, for example, to execute a program which describes the process content described in the modified example. More specifically, the functions of the mobile terminal 10 can be realized by executing a program corresponding to processes performed by the mobile terminal 10 by using hardware resources such as a CPU, and a memory and the like in the computer. The program can be saved and distributed by recording the program in a computer readable recording medium (such as portable memory). Also, the program can be provided via a network such as the Internet, an electronic mail and the like.

The quality-of-experience optimization apparatus 30 of the modified example includes a throughput calculation and transmission unit 41, the quality related information reception unit 32, and the quality related information DB 33. That is, the quality-of-experience optimization apparatus 30 in the modified example includes the throughput calculation and transmission unit 41 instead of the optimized coding information calculation unit 31 in the quality-of-experience optimization apparatus 30 shown in FIG. 3. The quality related information reception unit 32 and the quality related information DB 33 are the same as those shown in FIG. 3.

The throughput calculation and transmission unit 41 includes functions that predict, in response to receiving a request including a CID from the mobile terminal 10, throughput at the current position of the mobile terminal 10 based on the CID, the current time and the quality related information stored in the quality related information DB 33, and transmit the throughput prediction value (specifically, for example, throughput average and throughput dispersion) to the mobile terminal 10.

Note that the quality-of-experience optimization apparatus 30 of the modified example may be referred to as a network quality estimation apparatus.

The quality-of-experience optimization apparatus 30 in the modified can be realized by causing one or more computers, for example, to execute a program which describes the process content described in the modified example. More specifically, the functions of the quality-of-experience optimization apparatus 30 can be realized by executing a program corresponding to processes performed by the quality-of-experience optimization apparatus 30 by using hardware resources such as a CPU, and a memory and the like in the computer. The program can be saved and distributed by recording the program in a computer readable recording medium (such as portable memory). Also, the program can be provided via a network such as the Internet, an electronic mail and the like.

As described above, the hardware configuration example of the mobile terminal 10 and the quality-of-experience optimization apparatus 30 in the modified example is the same as the configuration shown in FIG. 6.

### Operation Example in the Modified Example

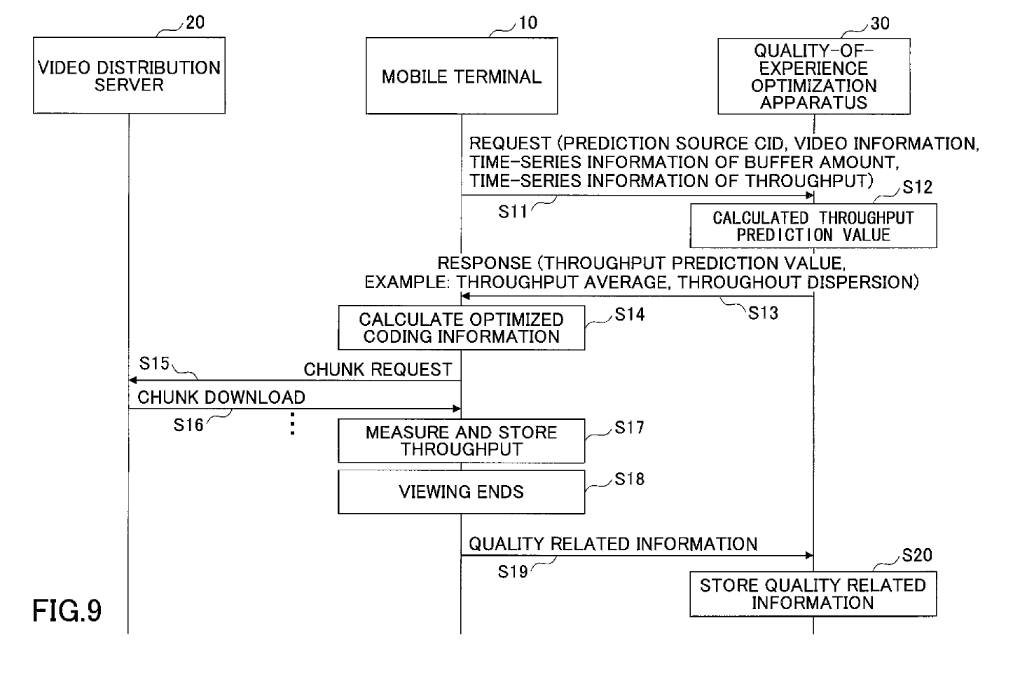

FIG. 9 is a sequence diagram of the quality-of-experience optimization system 100 in the modified example.

First, like step S1 in FIG. 3, the optimized coding information calculation unit 21 of the mobile terminal 10 transmits, to the quality-of-experience optimization apparatus 30, a request including a CID of the current location of the mobile terminal 10, video information, time-series information of the buffer amount, and time-series information of throughput (step S11). The timing when step S11 is executed is when video viewing starts, or the cell (base station) where the mobile terminal 10 resides changes (that is, the CID changes), or the like. Note that, in step S11, it is merely an example that the information transmitted from the mobile terminal 10 to the quality-of-experience optimization apparatus 30 includes the CID of the current location, the video information, the time-series information of the buffer amount, and the time-series information of the throughput in step S11. For example, the information transmitted from the mobile terminal 10 to the quality-of-experience optimization apparatus 30 may be only the CID of the current location, or may be information including the CID of the current location and information other than “video information, time-series information of buffer amount, time-series information of throughput”.

The throughput calculation and transmission unit 41 of the quality-of-experience optimization apparatus 30 that receives the request transmitted in step S11 calculates the throughput prediction value (step S12).

Here, the throughput calculation and transmission unit 41 searches the quality related information DB 33 (example: FIG. 5) based on the CID included in the request and the current time (corresponding to playback time when playback of the video is performed in the mobile terminal 10) to obtain throughput data measured in the past under similar condition corresponding to the CID and the playback time, and calculates a throughput prediction value in the current mobile terminal 10 by calculating the average of the throughput data, for example. Throughput data under similar conditions in the past means, for example, throughput data measured at the same time zone (for example, 6 p.m.-8 p.m., etc.) on the same day of the week as the current time, in which the CID is the same as the CID of the request, and the like. The throughput calculation and transmission unit 41 calculates, for example, an average of throughputs and a variance of the throughputs as the throughput prediction value, but these are examples, and values other than these may be calculated, or only the average of the throughputs may be calculated. The throughput calculation and transmission unit 41 may calculate the throughput prediction value using the before-mentioned equation 1 or equation 2.

The throughput calculation and transmission unit 41 transmits the throughput prediction value calculated in step S12 to the mobile terminal 10 (step S13).

The optimized coding information calculation unit 21 of the mobile terminal calculates a coding condition (coding bit rate, frame rate, resolution) for optimizing the quality of experience from the throughput prediction value received on step S13, for example, the time-series information of the buffer amount, the coding information such as the bit rates usable in the video, and the like, and sends the calculation result (optimized coding information) to the video playback unit 11 (step S14). The calculation method of the coding condition is the same as that described in step S2 of FIG. 3. That is, the optimized coding information calculation unit 21 inputs, to the model equation, various coding conditions (coding bit rate, frame rate, resolution) usable in the target video and the like so as to calculate the estimated quality of experience under each coding condition.

Also, the optimized coding information calculation unit 21 determines, as the optimized coding information, a coding condition by which the estimated quality of experience is the largest among the coding conditions having a coding bit rate lower than the throughput prediction value. As described before, by using a coding bit rate lower than the throughput prediction value, it becomes possible to view high quality video without causing playback stop, and the quality of experience is optimized.

The subsequent steps S15 to S20 are the same as the steps S4 to S9 shown in FIG. 3.

### Summary of Embodiments

According to an embodiment of the present invention, there is provided a quality-of-experience optimization apparatus for optimizing quality of experience that a user experiences for a video distributed from a video distribution server via a network, including:

a quality related information database that stores duality information indicating network duality together with time information indicating a time when the network quality was measured, and position information indicating a position where the network quality was measured;

estimation means that obtains, from the quality related information database, quality information that satisfies a predetermined condition corresponding to a playback position that is a position where playback of the video is performed and to a playback time that is a time when the playback is performed, and estimates network quality at the playback position and the playback time based on the quality information; and

calculation means that calculates a recommended value of a coding condition of the video such that quality of experience of the video is optimized based on the network quality estimated by the estimation means and coding conditions that are usable for the video.

The optimized coding information calculation unit 31 is an example of configuration including the estimation means and the calculation means.

The quality-of-experience optimization apparatus may include quality related information reception means that receives, from a mobile terminal that performs playback of a video, the quality information, the position information, and the time information, and stores them in the quality related information database.

The network quality estimated by the estimation means is, for example, a throughput prediction value, and the calculation means calculates a coding bit rate that is below the throughput prediction value as the recommended value.

Also, according to an embodiment of the present invention, there is provided a mobile terminal that can communicate with the quality-of-experience optimization apparatus, including:

obtaining means that obtains position information indicating a position of the mobile terminal, transmits the position information to the quality-of-experience optimization apparatus as information indicating the playback position, and receives the recommended value from the quality-of-experience optimization apparatus; and

video playback means that requests the video distribution server to distribute a video corresponding to the recommended value obtained by the obtaining means, and playbacks video data distributed according to the request.

The optimized coding information obtaining unit 12 is an example of the obtaining means, and the video playback unit 11 is an example of the video playback means.

The video playback means may include means that measures the network quality when receiving the video data, the mobile terminal may further include quality related information transmission means that transmits, to the quality-of-experience optimization apparatus, quality information obtained by the measurement together with time information and position information.

Also, according to an embodiment of the present invention, there is provided a network quality estimation apparatus for estimating network quality that is used for optimizing quality of experience that a user experiences for a video distributed from a video distribution server via a network, including:

a quality related information database that stores quality information indicating network quality together with time information indicating a time when the network quality was measured, and position information indicating a position where the network quality was measured; and

estimation means that obtains, from the quality related information database, duality information that satisfies a predetermined condition corresponding to a playback position that is a position where playback of the video is performed and to a playback time that is a time when the playback is performed, and estimates network quality at the playback position and the playback time based on the quality information.

The throughput calculation and transmission unit 41 is an example of the estimation means.

Also, according to an embodiment of the present invention, there is provided a mobile terminal that can communicate with the network quality estimation apparatus, including:

obtaining means that obtains position information indicating a position of the mobile terminal, transmits the position information to the network quality estimation apparatus as information indicating the playback position, and receives the network quality from the network quality estimation apparatus;

calculation means that calculates a recommended value of a coding condition of the video such that quality of experience of the video is optimized based on the network quality obtained by the obtaining means and coding conditions that are usable for the video; and

video playback means that requests the video distribution server to distribute a video corresponding to the recommended value calculated by the calculation means, and playbacks video data distributed according to the request.

The optimized coding information calculation unit 21 is an example of a configuration including the obtaining means and the calculation means. The video playback unit 11 is an example of the video playback means.

The “means” in the configurations of each of the above apparatuses may be replaced with “unit”, “circuit”, “device” and the like.

According to the present embodiment, iii becomes possible that, even when a terminal that receives a video provided by a video distribution service moves, the terminal can receive a video for which quality of experience is optimized in the environment of the moving destination of the terminal. Accordingly, improvement of video viewing quality during movement is realized for a user who is viewing video while moving. As a result, it is expected to differentiate from services of other peers in the same industry, to increase the staying time of the video distribution service applying the technology according to the present invention, and to increase the frequency of use.

Embodiments of the present invention have been described in detail. However, the present invention is not limited to the above-mentioned specific embodiments, and can be variously modified and changed within the scope of the present invention described in the claims.

The present patent application claims priority based on Japanese patent application No. 2015-236086, filed in the JPO on Dec. 2, 2015, and the entire contents of the Japanese patent application No. 2015-236086 are incorporated herein by reference.

### DESCRIPTION OF REFERENCE SIGNS

10 mobile terminal
11 video playback unit
12 optimized coding information obtaining unit
13 quality related information DB
14 quality related information transmission unit
20 video distribution server
30 quality-of-experience optimization apparatus
21, 31 optimized coding information calculation unit
32 quality related information reception unit
33 quality related information DB
41 throughput calculation and transmission unit
100 quality-of-experience optimization system
150 drive device
152 auxiliary storage device
153 memory device
154 CPU
155 interface device
156 display device
157 input device

1. A quality-of-experience optimization apparatus for optimizing quality of experience that a user experiences for a video distributed from a video distribution server via a network, comprising:
a quality related information database that stores quality information indicating network quality together with time information indicating a time when the network quality was measured, and position information indicating a position where the network quality was measured;
an estimation unit that obtains, from the quality related information database, quality information that satisfies a predetermined condition corresponding to a playback position that is a position where playback of the video is performed and to a playback time that is a time when the playback is performed, and estimates network quality at the playback position and the playback time based on the quality information; and
a calculation unit that calculates a recommended value of a coding condition of the video such that quality of experience of the video is optimized based on the network quality estimated by the estimation unit and coding conditions that are usable for the video.

2. The quality-of-experience optimization apparatus as claimed in claim 1, comprising:
a quality related information reception unit that receives, from a mobile terminal that performs playback of a video, the quality information, the position information, and the time information, and stores them in the quality related information database.

3. The quality-of-experience optimization apparatus as claimed in claim 1, wherein
the network quality estimated by the estimation unit is a throughput prediction value, and the calculation unit calculates a coding bit rate that is below the throughput prediction value as the recommended value.

4. A mobile terminal that can communicate with the quality-of-experience optimization apparatus as claimed in claim 1, comprising:
an obtaining unit that obtains position information indicating a position of the mobile terminal, transmits the position information to the quality-of-experience optimization apparatus as information indicating the playback position, and receives the recommended value from the quality-of-experience optimization apparatus; and
a video playback unit that requests the video distribution server to distribute a video corresponding to the recommended value obtained by the obtaining unit, and playbacks video data distributed according to the request.

5. The mobile terminal as claimed in claim 4, wherein the video playback unit includes a unit that measures the network quality when receiving the video data, the mobile terminal further comprises:
a quality related information transmission unit that transmits, to the quality-of-experience optimization apparatus, quality information obtained by the measurement together with time information and position information.

6. A network quality estimation apparatus for estimating network quality that is used for optimizing quality of experience that a user experiences for a video distributed from a video distribution server via a network, comprising:
a quality related information database that stores quality information indicating network quality together with time information indicating a time when the network quality was measured, and position information indicating a position where the network quality was measured; and
an estimation unit that obtains, from the quality related information database, quality information that satisfies a predetermined condition corresponding to a playback position that is a position where playback of the video is performed and to a playback time that is a time when the playback is performed, and estimates network quality at the playback position and the playback time based on the quality information.

7. A mobile terminal that can communicate with the network quality estimation apparatus as claimed in claim 6, comprising:
an obtaining unit that obtains position information indicating a position of the mobile terminal, transmits the position information to the network quality estimation apparatus as information indicating the playback position, and receives the network quality from the network quality estimation apparatus;
a calculation unit that calculates a recommended value of a coding condition of the video such that quality of experience of the video is optimized based on the network quality obtained by the obtaining unit and coding conditions that are usable for the video; and
a video playback unit that requests the video distribution server to distribute a video corresponding to the recommended value calculated by the calculation unit, and playbacks video data distributed according to the request.

8. A quality-of-experience optimization method executed by a quality-of-experience optimization apparatus for optimizing quality of experience that a user experiences for a video distributed from a video distribution server via a network,
wherein the quality-of-experience optimization apparatus includes a quality related information database that stores quality information indicating network quality together with time information indicating a time when the network quality was measured, and position information indicating a position where the network quality was measured, the quality-of-experience optimization method comprising:
an estimation step of obtaining, from the quality related information database, quality information that satisfies a predetermined condition corresponding to a playback position that is a position where playback of the video is performed and to a playback time that is a time when the playback is performed, and estimating network quality at the playback position and the playback time based on the quality information; and
a calculation step of calculating a recommended value of a coding condition of the video such that quality of experience of the video is optimized based on the network quality estimated by the estimation step and coding conditions that are usable for the video.

9. A network quality estimation method executed by a network quality estimation apparatus for estimating network quality that is used for optimizing quality of experience that a user experiences for a video distributed from a video distribution server via a network,
wherein the network quality estimation apparatus includes a quality related information database that stores quality information indicating network quality together with time information indicating a time when the network quality was measured, and position information indicating a position where the network quality was measured, the network quality estimation method comprising:
an estimation step of obtaining, from the quality related information database, quality information that satisfies a predetermined condition corresponding to a playback position that is a position where playback of the video is performed and to a playback time that is a time when the playback is performed, and estimating network quality at the playback position and the playback time based on the quality information.

10. A non-transitory computer readable recording medium storing a program for causing a computer to function as each unit of the quality-of-experience optimization apparatus as claimed in claim 1.

11. A non-transitory computer readable recording medium storing a program for causing a computer to function as each unit of the network quality estimation apparatus as claimed in claim 6.

12. A non-transitory computer readable recording medium storing a program for causing a computer to function as each unit of the mobile terminal as claimed in claim 4.
